(19) United States
(12) Patent Application Publication
(10) Pub. No.: US 2015/0111525 A1
(43) Pub. Date: Apr. 23, 2015

(54) EMERGENCY ASSISTANCE

(71) Applicant: Geoffrey M. Crockett, Salt Lake City, UT (US)

(72) Inventors: Geoffrey M. Crockett, Salt Lake City, UT (US); Jarrod Wilson, Kalamazoo, MI (US)

(21) Appl. No.: 14/509,259

(22) Filed: Oct. 8, 2014

Related U.S. Application Data
(60) Provisional application No. 61/894,169, filed on Oct. 22, 2013.

(51) Int. Cl. H04W 4/22; H04L 12/58; H04W 4/14; H04W 4/02

(52) U.S. Cl. CPC H04W 4/22; H04W 4/02; H04L 51/38; H04W 4/14
USPC 455/404.2

(57) ABSTRACT

The principles described herein include systems and devices for providing emergency assistance to a user with an electronic communication device. One such method includes, determining if an emergency service is compliant with an emergency service standard, formatting Simple Message Service (SMS) messages to be compliant with emergency service standards, transmitting emergency SMS messages to emergency services and emergency contacts, displaying the user's address and location on a map using the device, dictating the user's location to the user and/or the emergency service, highlighting nearby and relevant emergency services on the map, initiating a voice session with the emergency service, and providing silent mode operation where sounds from the device are suppressed. Another method includes detecting a call to an emergency service and in response to detecting that call, displaying the user's location to the user.

### BACKGROUND

In an emergency situation it is common in many countries for people to use a landline or mobile telephone to call a Public Safety Answering Point (PSAP) in order to receive help. In the United States, the emergency number is 9-1-1; in many European countries the number is 1-1-2. A PSAP is often a call center where operators are responsible for answering emergency calls and dispatching the appropriate emergency services. Help is provided by emergency services such as police, firefighting and ambulance services.

Often, the difference between life and death in an emergency situation relies on how quickly emergency services can reach the site or person with the emergency. People with an emergency and emergency services personnel benefit from quicker response times by having good communication and pertinent information readily available.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of a system for providing assistance in an emergency to a user with an electronic communication device, according to one example of principles described herein.

FIG. 2 is a flow chart of a method (200) for providing assistance in an emergency to a user with an electronic communication device, according to one example of principles described herein.

FIG. 3 is flow chart of a method of providing assistance in an emergency to a user with an electronic communication device, according to one example of principles described herein.

FIGS. 4A and 4B show flow charts of methods for determining if an emergency service is compliant with an emergency standard, according to one example of principles described herein.

FIG. 5A shows an SMS formatted for emergency services that are equipped to parse SMS messages automatically, according to one example of principles described herein.

FIG. 5B shows an example of a formatted SMS message to an emergency service that is not equipped to automatically translate GPS coordinates into an address or where the compliance with any emergency service standards of the emergency service is unknown, according to one example of principles described herein.

FIG. 6 is an example image of displaying a user's address with text and location on a map, according to one example of principles described herein.

FIG. 7 shows an example image of highlighting emergency service locations on a map, according to one example of principles described herein.

FIG. 8 shows an example image of highlighting relevant emergency service locations, according to one example of principles described herein.

FIG. 9 shows an example image of providing directions to an emergency service location, according to one example of principles described herein.

FIG. 10 is a flow chart of an example method for providing silent mode operation, according to one example of principles described herein.

FIG. 11 is a flow chart of an example method for providing an incapacitated mode, according to one example of principles described herein.

FIG. 12 is a diagram of an example of an electronic communication device for providing emergency assistance to a user in an emergency, according to one example of principles described herein.

Throughout the drawings, identical reference numbers designate similar, but not necessarily identical, elements.

### DETAILED DESCRIPTION

In an emergency situation it is common in many countries for people to use a landline or mobile telephone to call a Public Safety Answering Point (PSAP) in order to receive help. In the United States, the emergency number is 9-1-1; in many European countries the number is 1-1-2. A PSAP is often a call center where operators are responsible for answering emergency calls and dispatching the appropriate emergency services. Help is provided by emergency services such as police, firefighting, and ambulance services.

Often, the difference between life and death in an emergency situation relies on how quickly emergency services can reach the site or person with the emergency. People with an emergency and emergency services personnel benefit from quicker response times by having good communication and information readily available. To aid with this, emergency service standards have been established to facilitate communications between emergency callers and PSAPs.

The principles described herein include systems and devices for providing emergency assistance to a user with an electronic communication device. One such method includes, determining if an emergency service is compliant with an emergency service standard, formatting Simple Message Service (SMS) messages to be compliant with emergency service standards, transmitting emergency SMS messages to emergency services and emergency contacts, displaying the user's address and location on a map using the device, dictating the user's location to the user and/or the emergency service, highlighting nearby and relevant emergency services on the map, initiating a voice session with the emergency service, and providing silent mode operation where sounds from the device are suppressed. Another method includes detecting a call to an emergency service and in response to detecting that call, displaying the user's location to the user.

A computing device for providing assistance to a user in an emergency may include an emergency call detecting module, a compliance determining module, emergency service and emergency service database querying modules, and location presenting module which may include a dictating module.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

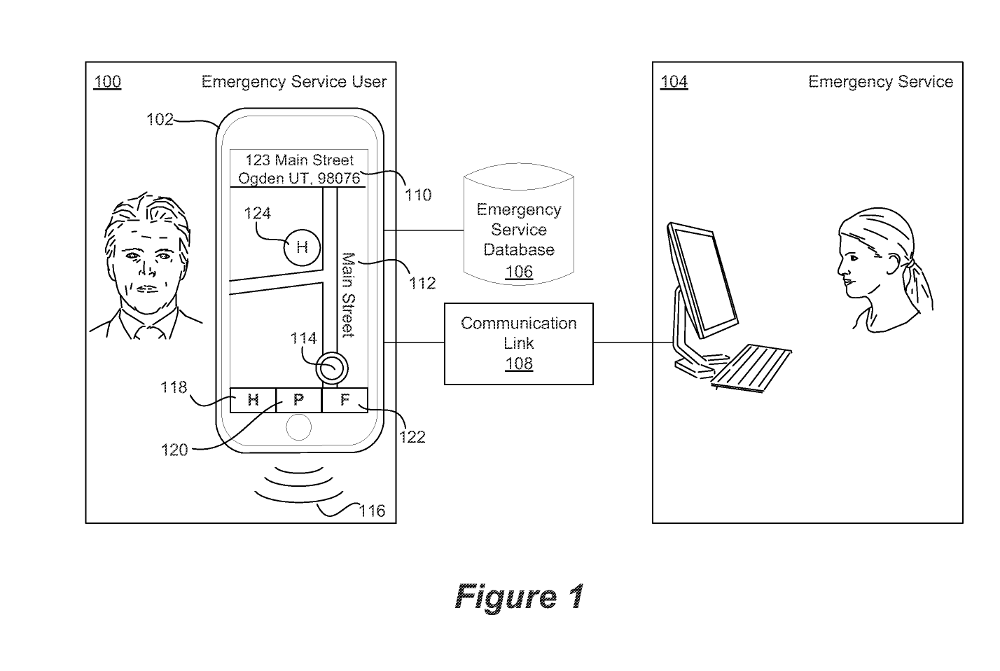

FIG. 1 is a diagram of an example of a system for providing assistance in an emergency to a user (100) with an electronic communication device (102). The system includes an emergency service user (100) with communication device (102). The communication device has access to an emergency service database (106). The emergency service database may be queried to discover with which, if any, emergency service standards a particular emergency service complies. For example, when the emergency service user makes an emergency call, the database may be queried to discover that the regional PSAP complies with standards that allow it to receive text messages with location information.

When the emergency service user makes an emergency call, a communication link (108) is established between the communication device (102) and an emergency service provider (104). Upon detecting a call made to an emergency service, the communication device processes software configured to translate GPS coordinates into an address (110), display a map (112) of the user's location (114), and read the user's location aloud (116). Using easily accessible buttons, the user can choose between showing different types of emergency services on the map as well. In this example, the user can choose to view hospitals (118), police (120), or firefighting locations (122). In this example, the user has selected hospitals and the location of a hospital (124) is displayed on the map.

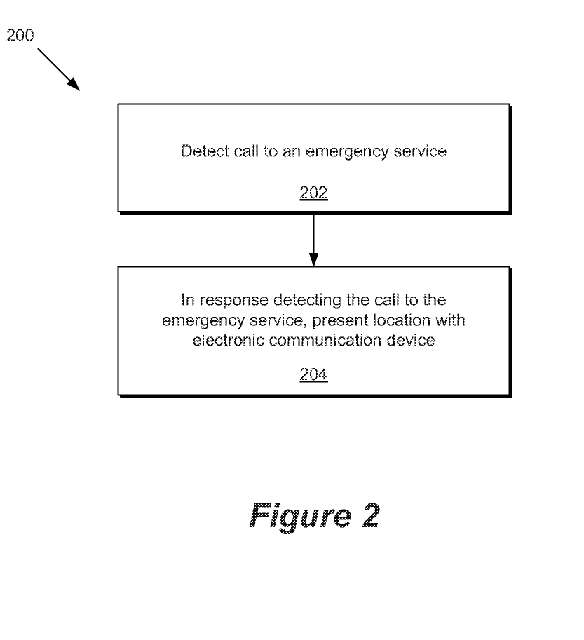

FIG. 2 is a flow chart of an example of a method (200) for providing assistance in an emergency to a user with an electronic communication device. For example, a user is driving an automobile in an unfamiliar area when they come across an accident. The user uses a mobile phone to call 9-1-1. The call to an emergency service is detected (block 202). In response to detecting the call to the emergency service, the user's location is presented to the user using the electronic communication device (block 204), in this example, a mobile phone. It is likely that one of the first things the emergency service will need to know is the location of the accident. The user will not need to take any extra time or effort to discover the location; the location is provided to them automatically.

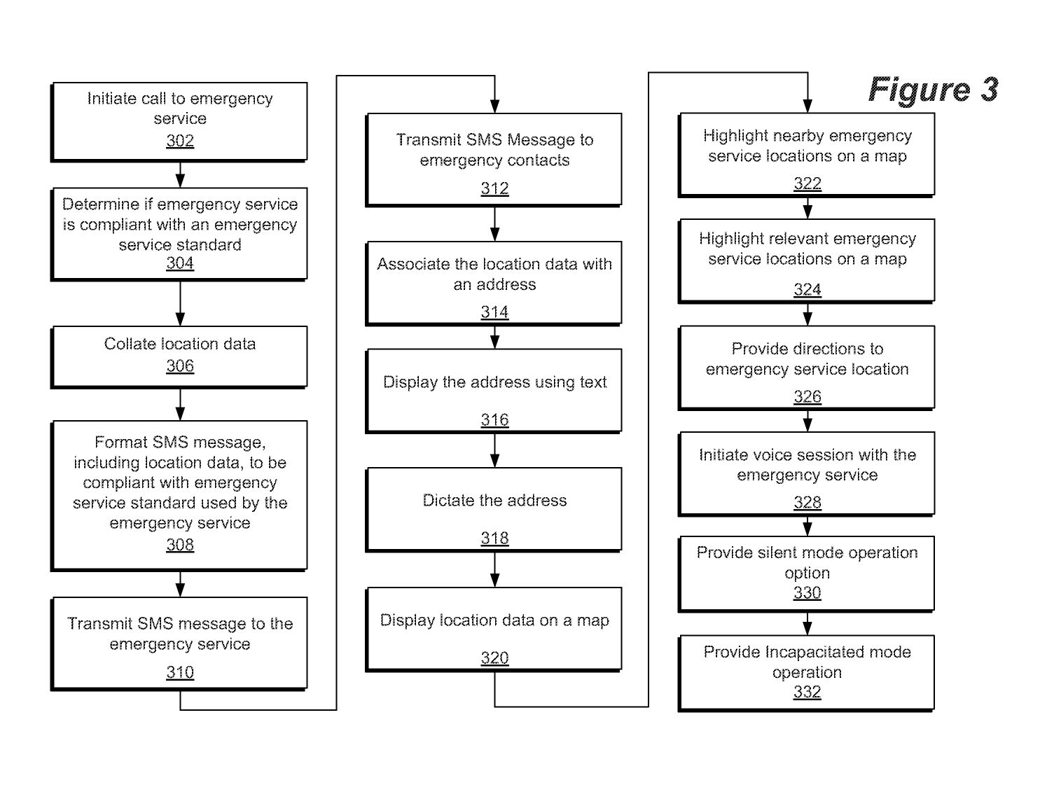

FIG. 3 is a flow chart of an example of a method of providing assistance in an emergency to a user with an electronic communication device. For example, a user is walking down an alley late at night and hears gunfire nearby. In response, the user hides behind a dumpster and uses their mobile phone to dial an emergency number. A call is initiated to an emergency service (block 302) from the mobile phone. In this example, a mobile phone is used as an example but any electronic communication device may be used.

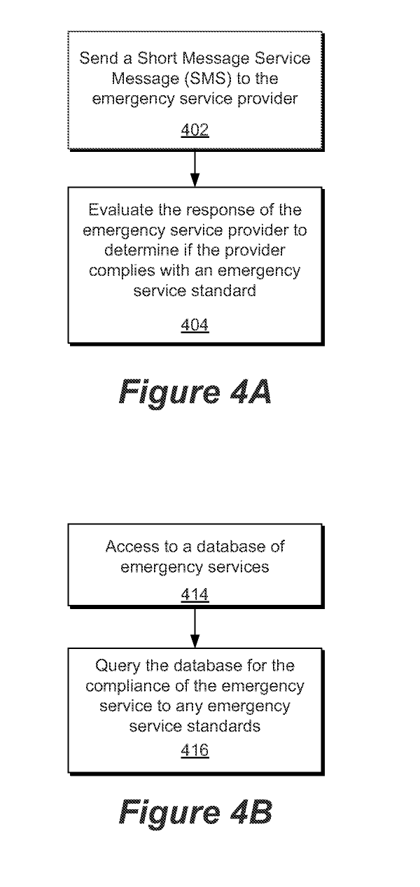

It is also determined if the emergency service being called is compliant with any emergency service standards (block 304). FIGS. 4A and 4B show flow charts of examples of methods for determining if an emergency service is compliant with an emergency standard. In FIG. 4A a Short Message Service (SMS) message is sent to an emergency provider (block 402). The response of the emergency service provider is evaluated to determine if the provider complies with an emergency service standard (block 404). For example, if the emergency service provider does not reply, it may be assumed that the provider does not comply with standards that require the service to respond to SMS messages. Or, the case may be that the service responds, identifying the standard to which it complies. In addition to SMS messages, a variety of other data communication methods could be used to query the emergency service provider and receive a response to determine if the emergency service provider complies with one or more emergency service standards. In FIG. 4B a database of emergency services is accessed (block 414). The database may be stored on the user's device or may be accessed remotely. The database is queried for the compliance of the emergency service to any emergency service standards (block 416). For example, the user's device may identify an emergency service using the user's location and then look up the closest appropriate emergency service from a location indexed database.

Referring again to FIG. 3, location data is collated (block 306) from positioning services or modules used on the mobile phone. For example, location data may be requested from an on board GPS module or an approximate location may be determined from services provided using a cell or Wi-Fi network.

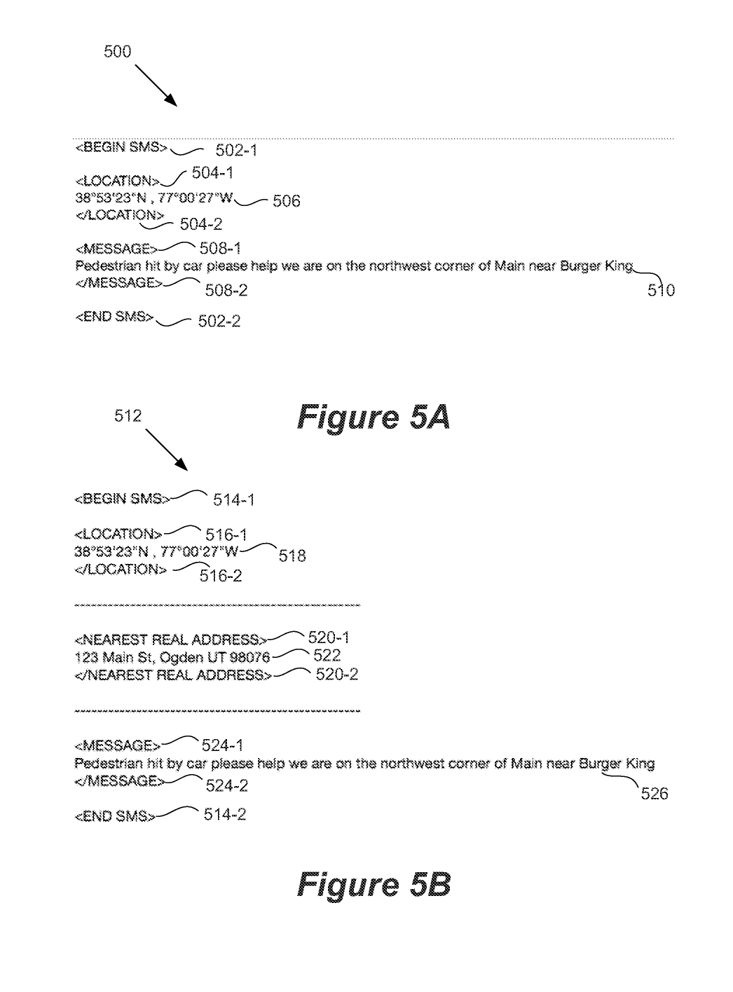

After location data has been collated, an SMS message or other message is formatted, which includes the location data, to be compliant with the emergency service standard used by the emergency service (block 308). Compliance with different emergency service standards may mean that emergency service providers are equipped to utilize different types of technology. For example, FIGS. 5A and 5B show examples of SMS message formatting. FIG. 5A shows an SMS formatted for emergency services that are equipped to parse SMS messages automatically (500). The scope SMS message is marked with a start tag labeled, “BEGIN SMS” (502-1) and end tag labeled “END SMS” (502-2) Different sections of the message are marked using start and end tags. A tag is distinguished by left and right angle brackets with the tag's label between the angle brackets. Start and end tags with the same label are distinguished with the end tag having an additional marker of “/” at the beginning of the label. This example message has two sections: a location section and a message section. The location section is marked by a start and end tags “<LOCATION>” (504-1) and “</LOCATION>” (504-2) respectively. Within the location section is listed the user's location in GPS coordinates (506). An emergency service provider that receives this type of message format would be able to translate the GPS coordinates to any format they needed including a street address. The message portion of the SMS message is marked by start and end brackets “<MESSAGE>” (508-1) and “</MESSAGE>” (508-2) respectively. The user specifies this message and can use it to give the emergency service provider information about their specific location and emergency.

FIG. 5B shows an example of a formatted SMS message (512) to an emergency service that is not equipped to automatically translate GPS coordinates into an address or where the compliance with any emergency service standards of the emergency service is unknown. As with the formatted message specified above, the message includes start (514-1) and end (514-2) tags to define the scope of the message, a location section with start and end tags, 516-1 and 516-2 respectively, containing a GPS location (518), and a message section with start and end tags, 524-1 and 524-2 respectively. Different from the example above, however, is that this message includes a nearest real address section with start and end brackets 520-1 and 520-2 respectively and a nearest real address (522). This address is included in case the emergency service provider doesn't have a method of parsing or utilizing GPS coordinates. Other additions may be included depending on the capabilities of the emergency service provider and electronic communication device. For example, a video message may be sent from the electronic communication device to the emergency service provider and the emergency service provider may use this information to determine the severity of the emergency, the personnel and equipment needed for the type of emergency, etc.

Returning to FIG. 3, the formatted SMS message is transmitted to the emergency service (block 310). In addition to sending an SMS message to the emergency service the user may also select contacts to be emergency contacts to which SMS messages are also sent (block 312).

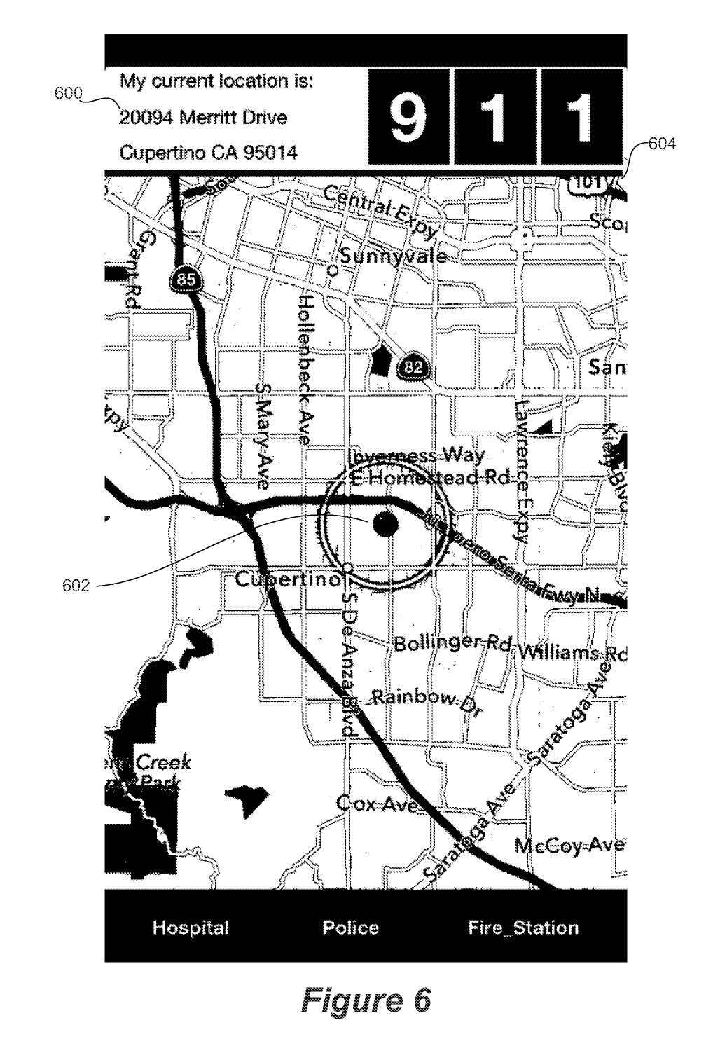

The location data is associated with a street address or other address (block 314), which may be more readily useable by the user. The address may then be presented to the user in a variety of ways. The mobile phone may display the address using text (block 316), dictate the address (block 318), and display the address or location data on a map (block 320). FIG. 6 is an example image of displaying a user's address with text and location on a map. In this example, the user's address (600) is displayed with text where it is easily seen and read. The user's location (602) is also displayed on a map (604) using a circular icon.

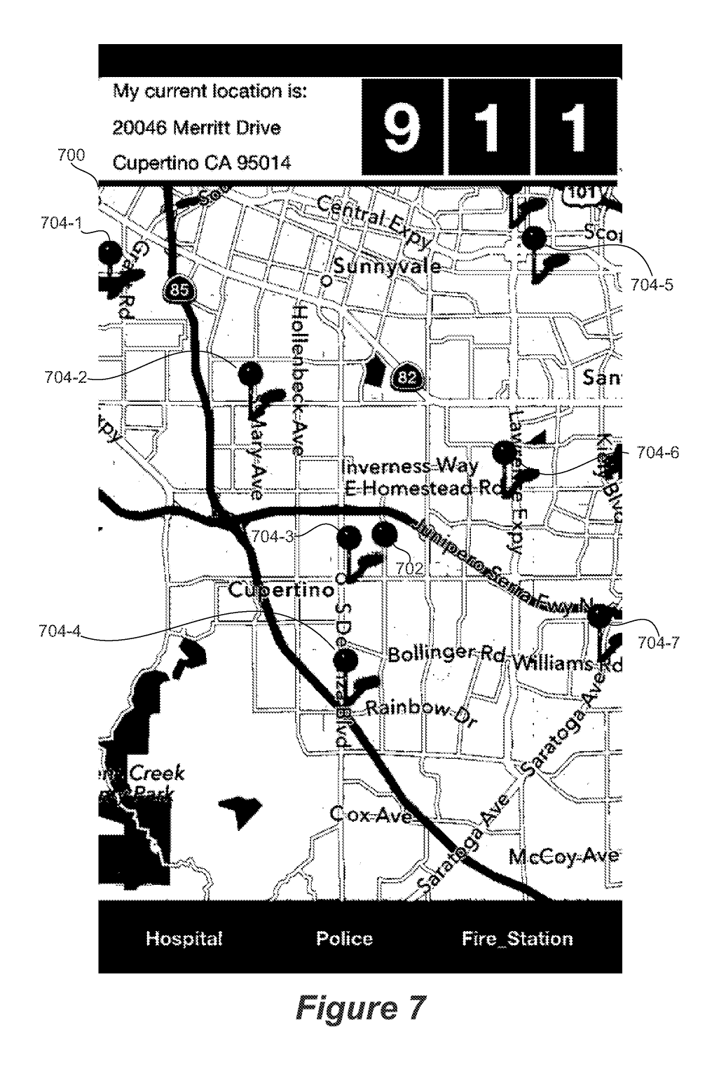

Referring to FIG. 3, in addition to showing the user's location on the map, nearby emergency service locations may be highlighted on the map as well (block 322). FIG. 7 shows an example image of highlighting emergency service locations on a map (700). The user's location is shown (702) on the map (700). Nearby emergency service locations (704-1, 704-2, 704-3, 704-4, 704-5, 704-6, and 704-7) are highlighted using pin icons. Other methods of highlighting nearby emergency service locations may also be used.

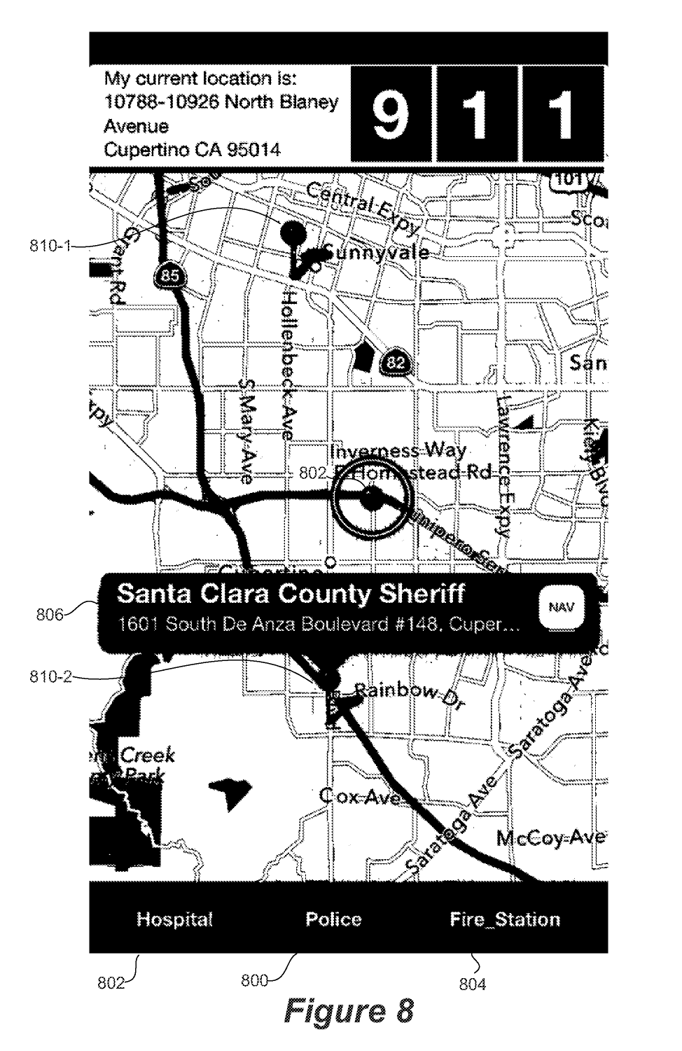

Referring to FIG. 3, relevant emergency service locations may also be highlighted on the map (block 324). A user may only want to view emergency services on the map that are relevant to their emergency. In the example above, the user hears gunfire; this user may want to highlight police services. FIG. 8 shows an example image of highlighting relevant emergency service locations. In this example, the “Police” button (800) is selected and only relevant police locations are displayed (810-1 and 810-2) such as sheriff's offices, police departments, etc. Options to highlight other emergency service types such as hospitals (802) and fire stations (804) may also be selected. A specific emergency service location may be selected and details about that location may be displayed (806). Details may include the service's name, address, and specific specialized services provided by the service.

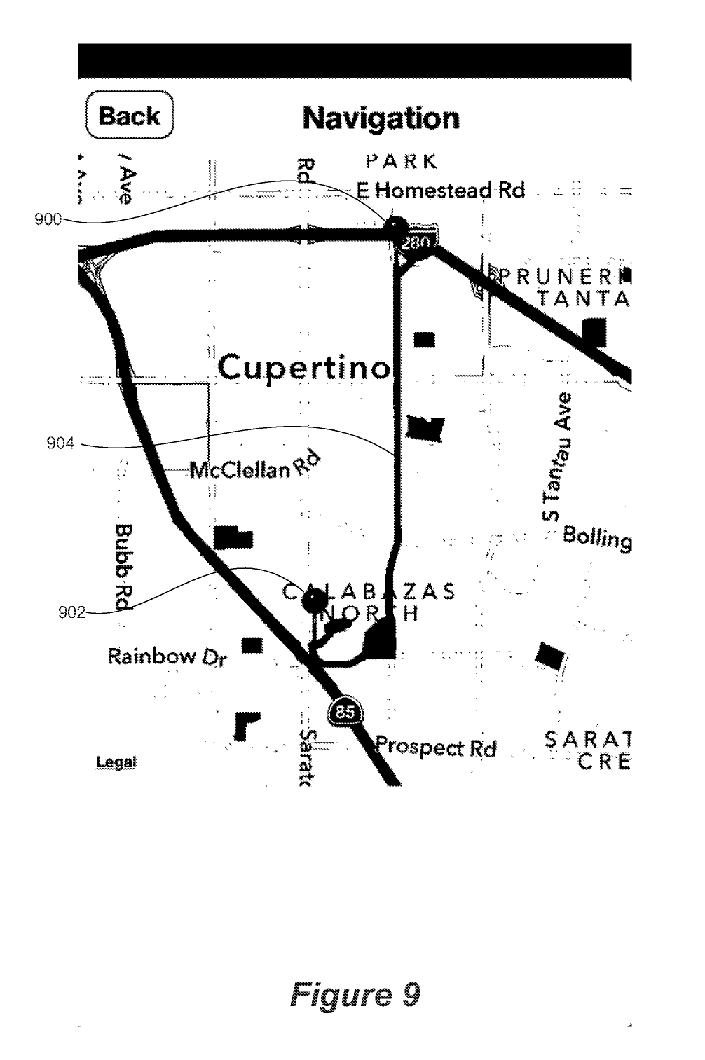

Referring again to FIG. 3, directions are provided to an emergency service location (326). FIG. 9 shows an example image of providing directions to an emergency service location. The user's location (900) is shown with a pin icon, the emergency service location (902) is shown in like manner. A generated route (904) is shown for traveling between the two locations.

Referring to FIG. 3, a voice session with the emergency service is initiated (block 328). In the example, the user hiding after hearing gunfire is able to report their emergency over a voice connection to the emergency service. However, if the user feels like they are threatened or in a dangerous situation, or is unable to speak or operate the communication device then additional assistance may be helpful. In this example a silent operation mode is provided (block 330) as well as an incapacitated mode (block 332).

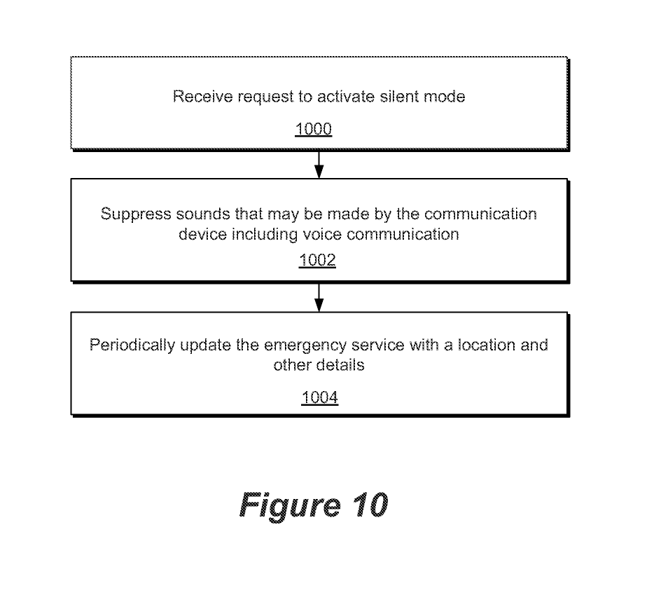

FIG. 10 is a flow chart of an example method for providing silent mode operation. The communication device receives a request to activate silent mode (block 1000). Sounds that may be issued by the device, including voice communication, are suppressed (block 1002). The emergency service is periodically updated with location data and other details (block 1004).

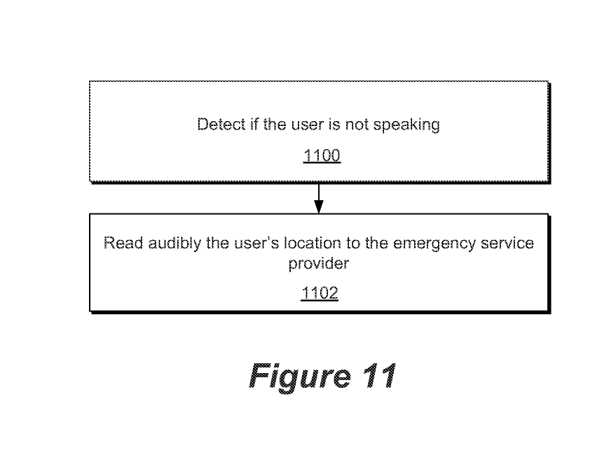

FIG. 11 is a flow chart of an example method for providing an incapacitated mode. The device detects if the user is not speaking (block 1100). This may be accomplished by monitoring audio levels and/or specific frequencies for a set period of time and triggering an alert if a certain amount of time has passed since the levels have met a certain threshold. If it is detected that a users is not speaking, then the user's location is read audibly to the emergency service provider (block 1102).

The methods described above are only examples. The principles described herein may be implemented in a variety of ways. For example, the blocks in the methods above may be reordered, combined, removed, or new blocks may be added. For example, in FIG. 3 blocks 316, 318, and 320 may all be performed simultaneously, may be performed individually or some of the blocks may not be performed in a given situation. Examples of a new block that could be added includes updating a location provided to the emergency service if a mobile device detects that the user has moved a predetermined distance after sending the initial location. These updates may continue as long as the user continues moving to different locations.

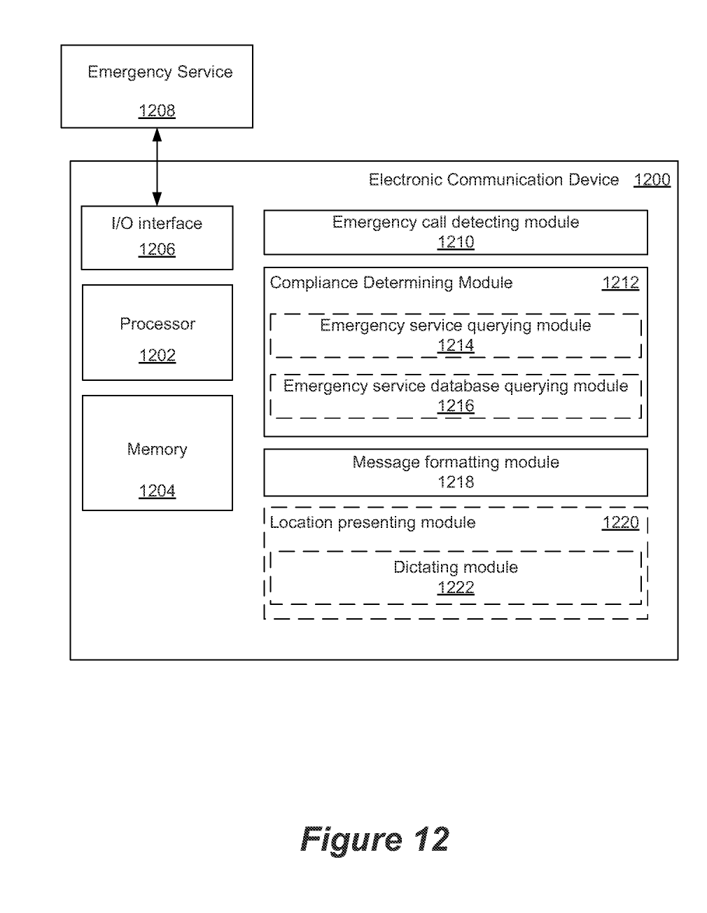

FIG. 12 is a diagram of an example of an electronic communication device (1200) for providing emergency assistance to a user in an emergency. The device includes a processor (1202) and memory (1204). Modules on the device use a combination of hardware and software resources to execute using the processor and memory. The electronic communication device also includes an I/O interface (1206) which may interface with an emergency service (1208). The electronic communication device also includes: an emergency call detecting module (1210) for detecting a call made to an emergency service. A compliance determining (1212) module for determining with which emergency service standards an emergency service complies. The compliance determining module may make use of an emergency service querying module (1214) or an emergency service database querying module (1216) to determine which emergency service standards with which the emergency service complies. A message formatting module (1218) for formatting the location data of the user according to an emergency service standard. A location presenting module (1220) for presenting a location of the user to the user in response to a call being made to an emergency service. The location presenting module may include a dictation module (1222) for dictating the location of the user.

The systems, methods, and devices presented have many benefits for users and emergency service providers. Users are provided important information pertinent to an emergency without having to retrieve it manually. Users may be presented with their address in many different formats so that reporting the address to the emergency service is facilitated. Modes are provided to report information to the emergency service provider in the event that the user is incapacitated or needs to keep silence. Users can see their location in relation to nearby and pertinent emergency service locations. This may allow a user to get to help faster than they would receive help if they waited for it to arrive. Emergency service providers automatically receive communications that match their compliance with emergency service standards. This saves the emergency service provider personnel time and effort and allows them to dispatch proper help more quickly and improves the likelihood of a desirable outcome to an emergency.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method of providing assistance in an emergency to a user with an electronic communication device comprising:
detecting a call to an emergency service; and
presenting a location of the user with the electronic communication device in response to detecting the call to the emergency service.

2. The method of claim 1, further comprising:
determining if the emergency service complies with an at least one emergency service standard;
collating the location of the user and personal data;
formatting a message to be compliant with the at least one emergency service standard; and
transmitting the message to the emergency service.

3. The method of claim 2, further comprising:
formatting an email to be compliant with the at least one emergency service standards; and
prioritizing transmission of the email so that it does not interfere with sending the message or with initiating a voice session.

4. The method of claim 1, wherein presenting the location of the user to the user comprises displaying the location of the user graphically with the electronic communication device.

5. The method of claim 4, wherein displaying the location of the user graphically with the electronic communication device comprises displaying the location of the user as an address using text.

6. The method of claim 4, wherein displaying the location of the user graphically with the electronic communication device comprises displaying the location of the user on a map.

7. The method of claim 6, further comprising:
highlighting, on the map, an at least one emergency service location that is near the location of the user location.

8. The method of claim 6, further comprising:
highlighting, on the map, an at least one emergency service location that is relevant to the emergency.

9. The method of claim 4, wherein displaying the location of the user graphically with the electronic communication device comprises displaying the location of the user as GPS coordinates using text.

10. The method of claim 1, wherein presenting the location of the user to the user comprises audibly reading the location of the user, with the electronic communication device.

11. The method of claim 2, wherein determining if the emergency service complies with an at least one emergency service standard comprises:
querying an emergency service database to determine if the emergency service complies with an at least one emergency service standard.

12. The method of claim 2, wherein determining if the emergency service complies with an at least one emergency service standard comprises:
querying the emergency service with a message to determine if the emergency service complies with an at least one emergency service standard.

13. The method of claim 1, further comprising:
dictating directions to an emergency service location from an at least one highlighted emergency service location on a map.

14. The method of claim 1, further comprising:
initiating a voice session with the emergency service provider;
sensing if the user is not speaking; and
reading audibly the location of the user to the emergency service provider.

15. A method of providing emergency assistance in an emergency to a user with an electronic communication device comprising:
initiating a call to an emergency service;
determining if the emergency service is compliant with an at least one emergency service standard;
collating location data from the electronic communication device;
formatting a Simple Message Service (SMS) message, which comprises the location data, to be compliant with the at least one emergency services standard;
transmitting the Simple Message Service (SMS) message to an at least one emergency service with the electronic communication device;
transmitting the Simple Message Service (SMS) message to an at least one emergency contact;
associating the location data with an address;
displaying the address using text with the electronic communication device;
dictating the address with the electronic communication device;
displaying the location data on a map using the electronic communication device;
highlighting an at least one emergency service location on the map;
providing directions to an at least one emergency service location;
initiating a voice session with the emergency service using the electronic communication device; and
providing a silent mode wherein location data is transmitted while an at least one sound which may be issued by the electronic communication device is suppressed.

16. A computing device for providing assistance to a user in an emergency comprising:
a processor;
a memory;
an I/O interface executed by the processor to send and receive SMS messages;
an emergency call detecting module executed by the processor for detecting a call made to an emergency service;
a compliance determining module executed by the processor to determine if the emergency service is compliant with an at least one emergency service standard;
a message formatting module executed by the processor for formatting the location data of the user according to the at least one emergency services standard.

17. The computing device of claim 16, wherein the compliance determining module comprises an emergency service querying module.

18. The computing device of claim 16, wherein the compliance determining module comprises an emergency service database querying module.

19. The computing device of claim 16, further comprising a location presenting module for presenting a location of the user to the user in response to a call being made to an emergency service.

20. The computing device of claim 19, further comprising a dictating module executed by the processor for dictating the location of the user.
